(19) United States
(12) Patent Application Publication
(10) Pub. No.: US 2009/0116556 A1
(43) Pub. Date: May 7, 2009

(54) DIGITAL IMAGE DECODING APPARATUS AND DIGITAL IMAGE DECODING METHOD

(75) Inventor: Takaya OGAWA, Kawasaki-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/263,748

(22) Filed: Nov. 3, 2008

(30) Foreign Application Priority Data
Nov. 7, 2007 (JP) 2007-289362

(51) Int. Cl. H04N 7/26

(52) U.S. Cl. 375/240.16; 375/E07.123

(57) ABSTRACT

A digital image decoding apparatus which decodes coded data using plurality of motion vectors in each block obtained by dividing an image in frame into a plurality of blocks. The digital image decoding apparatus comprises an error detection unit which detects an error of the block, a decoder which decodes the coded data to generate the motion vector, a motion vector setting unit which computes the motion vector of the block based on the motion vector generated by the decoder and sets the computed motion vector at the block, and a motion compensating decoder which performs motion compensating decoding using the motion vector set by the motion vector setting unit. The decoder generates a reference image motion vector by decoding the coded data of the image which motion compensation is performed to and used as a reference image. When the error detection unit detects the error in the block of the image to which the motion compensation is not performed, the motion vector setting unit computes the motion vector of the block of the image to which the motion compensation is not performed based on the reference image motion vector generated by the decoder, and sets the computed motion vector at the block of the image to which the motion compensation is not performed.

### CROSS-REFERENCE TO RELATED APPLICATION

This application is based upon and claims the benefit of priority from the prior Japanese Patent Application No. 2007-289362, filed on Nov. 7, 2007; the entire contents of which are incorporated herein by reference.

### BACKGROUND OF THE INVENTION

The present invention relates to a digital image decoding apparatus and a digital image decoding method, particularly the digital image decoding apparatus and digital image decoding method in which error concealment is performed when a decoding error occurs in a moving image coding system including motion compensation with a motion vector.

Conventionally, in a digital image decoding apparatus relating to a moving image codec, the concealment is performed by utilizing a motion vector of a neighboring macroblock with no error or a concealment motion vector which is transmitted along with macroblock information (for example, see Japanese Patent Publication Laid-Open No. 9-182076).

However, in the case of the use of the motion vector of the neighborhood macroblock with no error, there is no consideration for an image (hereinafter referred to as “I picture”) in which motion compensation is not performed.

In the case of the use of the concealment motion vector which is transmitted along with the macroblock information, the concealment motion vector is lost when the decoding error in a bit stream occurs.

In both the cases, as a result, error concealment of the I picture cannot be performed, and unfortunately frame dropout occurs when the decoded moving image is played.

### BRIEF SUMMARY OF THE INVENTION

According to a first aspect of the present invention, there is provided a digital image decoding apparatus which decodes coded data using plurality of motion vectors in each block obtained by dividing an image in frame into a plurality of blocks, the digital image decoding apparatus comprising:

an error detection unit which detects an error of the block;

a decoder which decodes the coded data to generate the motion vector;

a motion vector setting unit which computes the motion vector of the block based on the motion vector generated by the decoder and sets the computed motion vector at the block; and

a motion compensating decoder which performs motion compensating decoding using the motion vector set by the motion vector setting unit,

wherein the decoder generates a reference image motion vector by decoding the coded data of the image which motion compensation is performed to and used as a reference image, and

when the error detection unit detects the error in the block of the image to which the motion compensation is not performed, the motion vector setting unit computes the motion vector of the block of the image to which the motion compensation is not performed based on the reference image motion vector generated by the decoder, and sets the computed motion vector at the block of the image to which the motion compensation is not performed.

According to a second aspect of the present invention, there is provided a digital image decoding method for decoding coded data using plurarity of motion vectors in each block obtained by dividing an image in frame into a plurality of blocks, the digital image decoding method comprising:

detecting an error of the block;

decoding coded data of an image to which the motion compensation is performed and which is used as the reference image to generate a reference image motion vector;

computing the motion vector of the image to which the motion compensation is not performed based on the reference image motion vector, and setting the computed motion vector at the block of the image to which the motion compensation is not performed, when the error is detected in the block of the image to which the motion compensation is not performed; and

performing motion compensating decoding using the set motion vector.

### BRIEF DESCRIPTION OF THE DRAWINGS

FIG. 1 is a block diagram showing a configuration of a digital image decoding apparatus 10 according to the first embodiment of the present invention.

FIG. 2 is a diagrammatic illustration showing a schema of reference image motion vector 101C output from decoder 101.

FIG. 3 is a flowchart showing a processing procedure of digital image decoding processing of the first embodiment of the present invention performed by the digital image decoding apparatus 10.

FIG. 4 is a diagrammatic illustration showing effect of the first embodiment of the present invention.

FIG. 5 is a block diagram showing a configuration of a digital image decoding apparatus 20 according to the second embodiment of the present invention.

FIG. 6 is a flowchart showing a processing procedure of digital image decoding processing of the second embodiment of the present invention performed by the digital image decoding apparatus 20.

FIG. 7 is a diagrammatic illustration showing effect of the second embodiment of the present invention.

### DETAILED DESCRIPTION OF THE INVENTION

Exemplary embodiments of the present invention will be described below with reference to the drawings. The following embodiments of the present invention are described only by way of example, and the scope of the invention is not limited to the embodiments of the present invention.

First, definition of terms used in the embodiments of the present invention will be described.

In the embodiments of the invention, an image to which the motion compensation is performed and an image to which the motion compensation is not performed are dealt with. For example, in the case of MPEG2, the image to which the motion compensation is performed is a P picture and a B picture, and the image to which the motion compensation is not performed is an I picture. On the other hand, in the case of H.264, the image to which the motion compensation is performed is a picture including a P slice or a B slice, and the image to which the motion compensation is not performed is a picture including only I slices.

In the embodiments of the present invention, an image which is referred to in decoding the image to which the motion compensation is performed and which is located temporally near is referred to as reference image. For example, in the case of MPEG2, the I picture and the P picture can become the reference image. On the other hand, in the case of H.264, a picture having “nal_ref_idc” of 1 can become the reference image. A vector indicating a reference position of the motion compensation generated from the image to which the motion compensation is performed is referred to as motion vector, a motion vector generated from the image which can become the reference image is referred to as reference image motion vector, a vector indicating a residual component between an actual motion vector and a motion vector predicted from a neighboring block is referred to as differential motion vector, and the differential motion vector generated from the image which can become the reference image is referred to as reference image differential motion vector.

### First Embodiment

A first embodiment of the present invention will be described below.

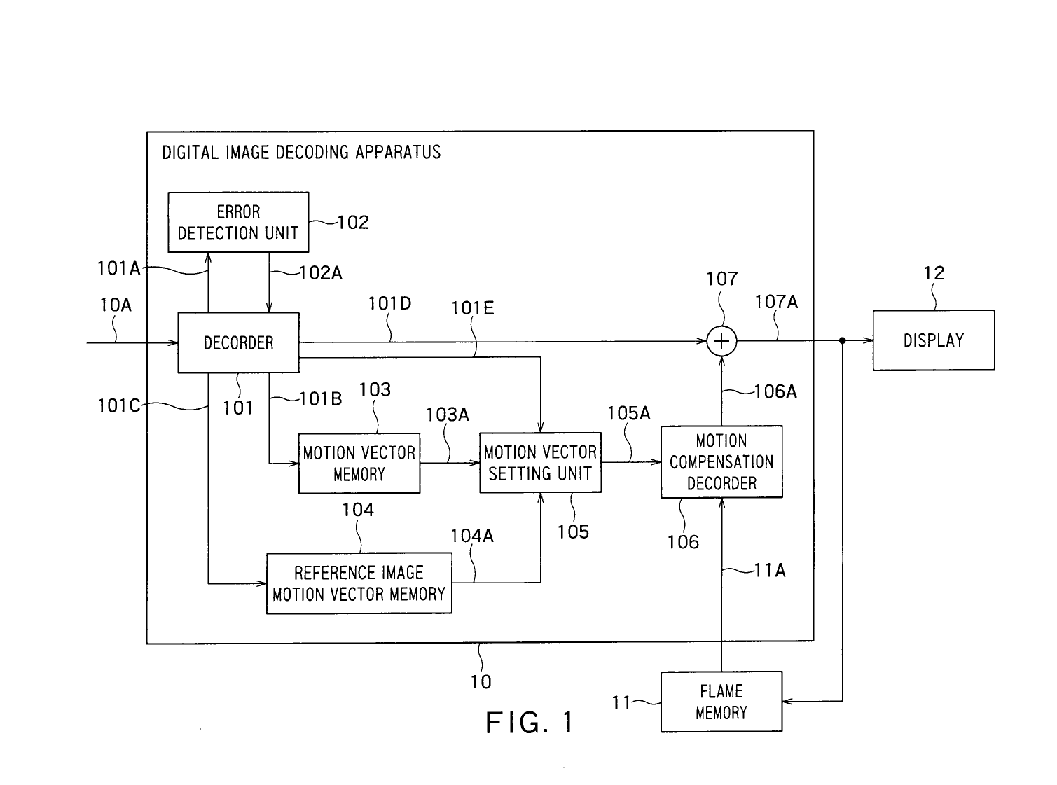

FIG. 1 is a block diagram showing a configuration of a digital image decoding apparatus 10 according to the first embodiment of the present invention.

The digital image decoding apparatus 10 of the first embodiment of the present invention includes a decoder 101, an error detection unit 102, a motion vector memory 103, a reference image motion vector memory 104, a motion vector setting unit 105, a motion compensating decoder 106, and an adder 107. The digital image decoding apparatus 10 is connected to a frame memory 11 and a display 12.

In FIG. 1, the numeral 10A designates coded data (bit stream), the numeral 101A designates error analytical coded data, the numeral 101B designates a motion vector, the numeral 101C designates a reference image motion vector, the numeral 101D designates differential decoded data, the numeral 101E designates an instruction signal, the numeral 102A designates an error flag, the numeral 103A designates a motion vector, the numeral 104A designates a reference image motion vector, the numeral 105A designates a set motion vector, the numeral 106A designates reference image data, the numeral 107A designates decoded image data, and the numeral 11A designates prediction image data.

The decoder 101 extracts the error analytical coded data 101A from the input coded data 10A. The decoder 101 performs decoding processing to the input coded data 10A to generate the motion vector 101B and the differential decoded data 101D. The decoder 101 generates not only the motion vector 101B but also the reference image motion vector 101C when the motion compensation is performed to the input coded data 10A and, at the same time, when the input coded data 10A is an image used as the reference image (for example, P picture of MPEG2).

In the decoding system (for example, H.264, MPEG2/4, and VC-1) of the decoder 101, one frame is divided into some macroblocks (hereinafter referred to as “block”), coding is performed in each block, and the motion compensating prediction is performed between temporally-neighboring frames in each block.

When the error flag 102A output from the error detection unit 102 is input into the decoder 101, that is, when an error is detected during the decoding, the decoder 101 issues the instruction signal 101E in order to set the motion vector for error block at the motion vector setting unit 105. The decoder 101 outputs the error analytical coded data 101A to the error detection unit 102, outputs the motion vector 101B of the currently-coding block to the motion vector memory 103, outputs the reference image motion vector 101C of the currently-coding block to the reference image motion vector memory 104, outputs the differential decoded data 101D to the adder 107, and outputs the instruction signal 101E to the motion vector setting unit 105.

For the sake of convenience, in the decoder 101, it is assumed that the coding and decoding are sequentially performed from the upper left corner to the right direction and, the next to the upper right corner, the coding and decoding are sequentially performed from the left end of the next block row to the right direction. When the plural motion vectors exist in one block while the decoder 101 generates the reference image motion vector 101C, a representative value is selected by any method (for example, an average operation).

The error detection unit 102 detects whether or not the error exists during the decoding performed by the decoder 101 on the basis of the error analytical coded data 101A output from the decoder 101. For example, the error detection unit 102 analyzes the error analytical coded data 101A to detect the error while the decoder 101 performs variable length decoding to the input coded data 10A. The error detection unit 102 outputs the error flag 102A to the decoder 101 when the error is detected.

Either header data in the coded data 10A or the coded data 10A of itself can be used as the error analytical coded data 101A, any pieces of data is used as long as the error necessary for the digital image decoding apparatus 10 of the first embodiment of the present invention can be detected, and the scope of the invention is not limited to the error analytical coded data 101A.

The motion vector memory 103 stores the motion vector 101B output from the decoder 101 in a predetermined motion vector storage area. The motion vector memory 103 has a storage capacity of one horizontal block line.

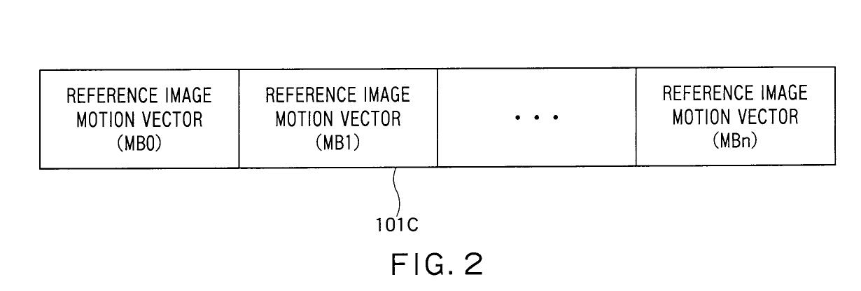

As shown in FIG. 2, the reference image motion vector memory 104 stores the reference image motion vector 101C output from the decoder 101 in the storage area corresponding to each block.

The motion vector setting unit 105 reads the motion vector 103A (for example, the motion vector corresponding to the block located immediately above the error block) stored in the predetermined storage area of the motion vector memory 103, sets the motion vector 105A at a predetermined block of the image of the input coded data 10A, and outputs the motion vector 105A to the motion compensating decoder 106. The motion vector setting unit 105 sets the reference image motion vector 104A stored in the reference image motion vector memory 104 at the error block of the image to which the motion compensation is not performed, and outputs the reference image motion vector 104A to the motion compensating decoder 106.

The motion compensating decoder 106 reads the reference image data 11A stored in the frame memory 11 which stores the temporally-neighboring frame to become the reference image according to the motion vector 105A output from the motion vector setting unit 105, and outputs the prediction image data 106A to the adder 107.

The adder 107 adds the differential decoded data 101D output from the decoder 101 and the reference image data 106A output from the motion compensating decoder 106. The adder 107 outputs the decoded image data 107A which is of the sum to the display 12. The adder 107 also outputs the decoded image data 107A to the frame memory 11 when the sum is used to predict the subsequent frames.

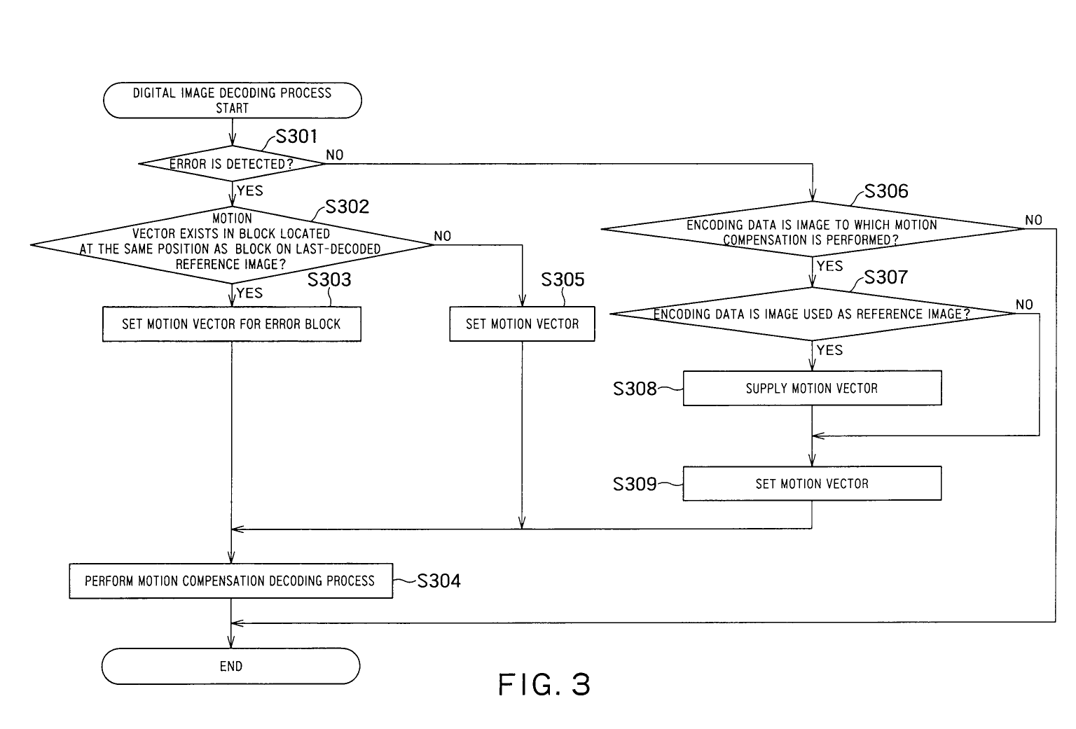

FIG. 3 is a flowchart showing a processing procedure of digital image decoding processing of the first embodiment of the present invention performed by the digital image decoding apparatus 10.

When the error is detected by the error detection unit 102 (YES in S301), and when the motion vector exists in the block located at the same position as the block on the last-decoded reference image (YES in S302), the motion vector setting unit 105 sets the motion vector of the block located at the same position as the block on the last-decoded reference image as the motion vector for error block (S303).

The motion compensating decoder 106 reads the prediction image data stored in the frame memory 11 which stores the temporally-neighboring frame to become the reference image according to the set motion vector to output the prediction image data to the adder 107 (S304). Then, the digital image decoding processing of the first embodiment of the present invention is ended.

On the other hand, when the error is detected by the error detection unit 102 (YES in S301), and when the motion vector does not exist in the block located at the same position as the block on the last-decoded reference image (NO in S302), the motion vector setting unit 105 sets the motion vector by a usual method (S305), and the flow goes to S304.

When the error is not detected by the error detection unit 102 (NO in S301), when the input coded data is the image to which the motion compensation is performed (YES in S306), and when the coded data is the image used as the reference image (YES in S307), the decoder 101 outputs the representative value of the reference image motion vector of the currently-coding block to the motion vector setting unit 105 (S308).

The motion vector setting unit 105 sets the reference image motion vector output in S308 at the predetermined block of the image of the input coded data (S309), and the flow goes to S304.

On the other hand, when the error is not detected by the error detection unit 102 (NO in S301), when the input coded data is the image to which the motion compensation is performed (YES in S306), and when the coded data is not the image used as the reference image (NO in S307), the flow goes to S309.

When the error is not detected by the error detection unit 102 (NO in S301), and when the input coded data is not the image to which the motion compensation is performed (NO in S306), the digital image decoding processing of the first embodiment of the present invention is ended.

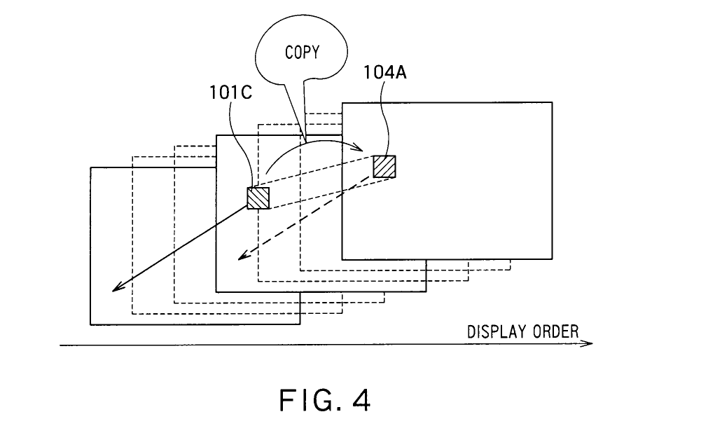

According to the first embodiment of the present invention, when the error is detected, the motion vector of the image to which the motion compensation is not performed is set using the motion vector of the image to which the motion compensation is performed. Therefore, the error concealment can be performed to the image to which the motion compensation is not performed, and therefore the frame dropout can be prevented when the decoded moving image is played. Particularly, as shown in FIG. 4, because the error concealment is performed by copying the previously-decoded reference image motion vector, for example, the first embodiment of the present invention is effectively applied to the case in which the whole screen is evenly moving and the case in which only a part of the screen is moving at a constant speed while the background stands still.

Additionally, according to the first embodiment of the present invention, for the coding system such as H.264 necessary to originally retain the reference image motion vector, the memory provided in the decoder 101 and the reference image motion vector memory 104 can be unified to achieve the above-described effect without increasing the memory capacity.

### Second Embodiment

A second embodiment of the present invention will be described below. The first embodiment of the present invention is an example in which the motion vector stored in the reference image motion vector memory is used. On the other hand, the second embodiment of the present invention is an example in which an average of the operated motion vectors of the plural blocks is used. The description of contents similar to those of the first embodiment of the present invention is neglected.

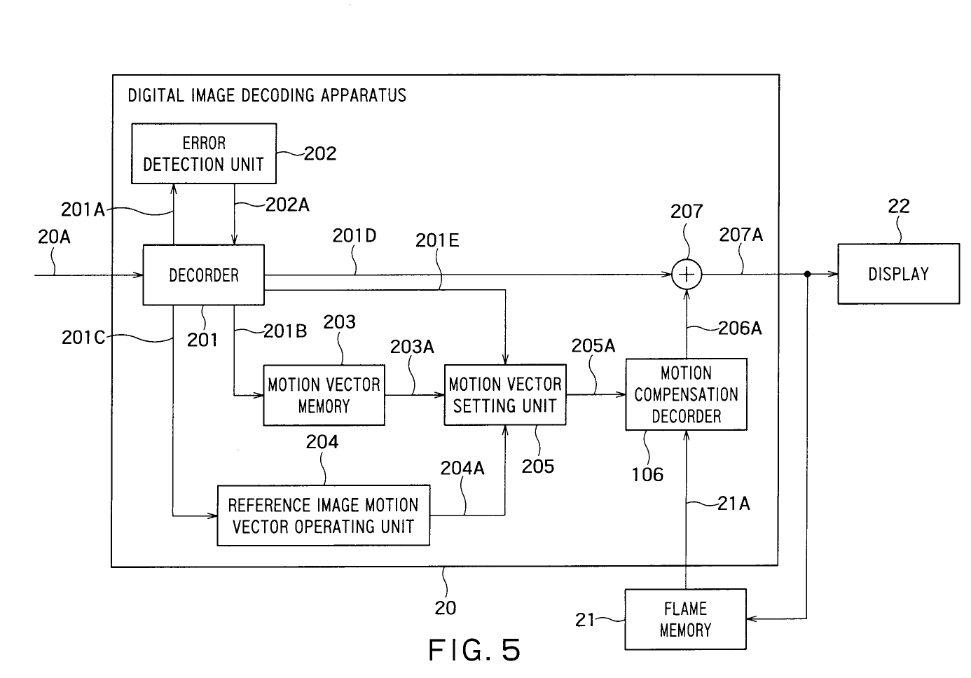

FIG. 5 is a block diagram showing a configuration of a digital image decoding apparatus 20 according to the second embodiment of the present invention.

The digital image decoding apparatus 20 of the second embodiment of the present invention includes a decoder 201, an error detection unit 202, a motion vector memory 203, a reference image motion vector operating unit 204, a motion vector setting unit 205, a motion compensating decoder 206, and an adder 207. The digital image decoding apparatus 20 is connected to a frame memory 21 and a display 22.

In FIG. 5, the numeral 20A designates coded data (bit stream), the numeral 201A designates error analytical coded data, the numeral 201B designates a motion vector, the numeral 201C designates a reference image motion vector and a reference image differential motion vector, the numeral 201D designates differential decoded data, the numeral 201E designates an instruction signal, the numeral 202A designates an error flag, the numeral 203A designates a motion vector, the numeral 204A designates an operated reference image motion vector, the numeral 205A designates a set motion vector, the numeral 206A designates reference image data, the numeral 207A designates decoded image data, and the numeral 21A designates prediction image data.

The decoder 201 extracts the error analytical coded data 201A from the input coded data 20A. The decoder 201 performs decoding processing to the input coded data 20A to generate the motion vector 201B and the differential decoded data 201D. The decoder 201 generates not only the motion vector 201B but also the reference image motion vector 201C when the motion compensation is performed to the input coded data 20A and, at the same time, when the input coded data 20A is the image used as the reference image (for example, P picture of MPEG2).

In the decoding system (for example, H.264, MPEG2/4, and VC-1) of the decoder 201, one frame is divided into some macroblocks (hereinafter referred to as “block”), the coding is performed in each block, and the motion compensating prediction is performed between temporally-neighboring frames in each block.

When the error flag 202A output from the error detection unit 202 is input into the decoder 201, that is, when the error is detected during the decoding, the decoder 201 issues the instruction signal 201E in order to set the motion vector for error block at the motion vector setting unit 205. The decoder 201 outputs the error analytical coded data 201A to the error detection unit 202, outputs the motion vector 201B of the currently-coding block to the motion vector memory 203, outputs the reference image motion vector and the reference image differential motion vector 201C of the currently-coding block to the reference image motion vector memory 204, outputs the differential decoded data 201D to the adder 207, and outputs the instruction signal 201E to the motion vector setting unit 205.

For the sake of convenience, in the decoder 201, it is assumed that the coding and decoding are sequentially performed from the upper left corner to the right direction and, the next to the upper right corner, the coding and decoding are sequentially performed from the left end of the next block row to the right direction. When the plural reference image differential motion vectors exist in one block while the decoder 201 generates the reference image motion vector and the reference image differential motion vector 201C, a representative value is selected by any method (for example, an average operation).

The error detection unit 202 detects whether or not the error exists during the decoding performed by the decoder 201 on the basis of the error analytical coded data 201A output from the decoder 201. For example, the error detection unit 202 analyzes the error analytical coded data 201A to detect the error while the decoder 201 performs variable length decoding to the input coded data 20A. The error detection unit 202 outputs the error flag 202A to the decoder 201 when the error is detected.

Either header data in the coded data 20A or the coded data 20A of itself can be used as the error analytical coded data 201A, any pieces of data is used as long as the error necessary for the digital image decoding apparatus 20 of the second embodiment of the present invention can be detected, and the scope of the invention is not limited to the error analytical coded data 201A.

The motion vector memory 203 stores the motion vector 201B output from the decoder 201 in a predetermined motion vector storage area. The motion vector memory 203 has a storage capacity of one horizontal block line.

The reference image motion vector operating unit 204 operates an average of plural reference image motion vectors 201C output from the decoder 201 and an average of absolute values of reference image differential motion vectors of the plural reference image motion vectors 201C, and outputs the operated reference image motion vector 204A to the motion vector setting unit 205.

The motion vector setting unit 205 reads the motion vector 203A (for example, the motion vector corresponding to the block located immediately above the error block) stored in the predetermined storage area of the motion vector memory 203, sets the motion vector 205A at a predetermined block of the image of the input coded data 20A, and outputs the motion vector 205A to the motion compensating decoder 206. The motion vector setting unit 205 sets the reference image motion vector 204A output from the reference image motion vector operating unit 204 at the error block of the image to which the motion compensation is not performed, and outputs the reference image motion vector 204A to the motion compensating decoder 206.

The motion compensating decoder 206 reads the reference image data 21A stored in the frame memory 21 which stores the temporally-neighboring prediction frame according to the motion vector 205A output from the motion vector setting unit 205, and outputs the prediction image data 206A to the adder 207.

The adder 207 adds the differential decoded data 201D output from the decoder 201 and the reference image data 206A output from the motion compensating decoder 206. The adder 207 outputs the decoded image data 207A which is of the sum to the display 22. The adder 207 also outputs the decoded image data 207A to the frame memory 21 when the sum is used to predict the subsequent frames.

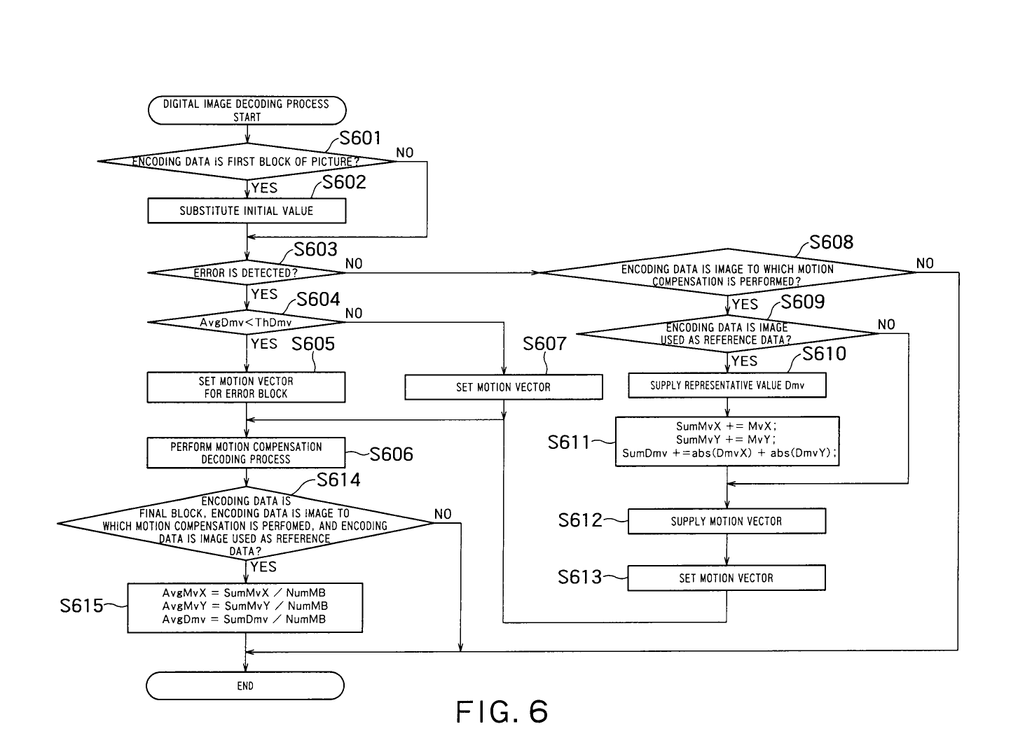

FIG. 6 is a flowchart showing a processing procedure of digital image decoding processing of the second embodiment of the present invention performed by the digital image decoding apparatus 20.

When the input coded data is a first block of the picture (YES in S601), the reference image motion vector operating unit 204 substitutes an initial value of “0” for the sum of X-coordinates of the motion vectors (SumMvX), the sum Y-coordinates of the motion vectors (SumMvY), and the sum of the reference image differential motion vectors (SumDmv) (S602). On the other hand, when the input coded data is not the first block of the picture (NO in S601), the flow goes to S603.

When the error is detected by the error detection unit 202 (YES in S603), and when the average of the absolute values of the reference image differential motion vectors (AvgDmv) is lower than a threshold of the reference image differential motion vector (ThDmv) (YES in S604), the motion vector setting unit 205 sets an average of the reference image motion vectors (AvgMvX, AvgMvY) as the motion vector for error block (S605).

The motion compensating decoder 206 reads the prediction image data stored in the frame memory 21 which stores the temporally-neighboring reference frame according to the set motion vector, and outputs the prediction image data to the adder 207 (S606).

When the input coded data is the final block of the picture and, at the same time, when the input coded data is the image to which the motion compensation is performed and, at the same time, when the input coded data is used as the reference image (YES in S614), the reference image motion vector operating unit 204 divides each of the sums SumMvX, SumMvY and SumDmv by the number of blocks included in one picture (NumMB), and updates the average of the reference image motion vectors (AvgMvX, AvgMvY) and the average of the absolute values of the reference image differential motion vectors (AvgDmv) (S615). Then, the digital image decoding processing of the second embodiment of the present invention is ended.

On the other hand, when the input coded data is not the final block of the picture, when the coded data is the image to which the motion compensation is not performed, or when the coded data is not used as the reference image (NO in S614), the digital image decoding processing of the second embodiment of the present invention is ended.

When the error is detected by the error detection unit 202 (YES in S603), and when the average of the absolute values of the reference image differential motion vectors (AvgDmv) is not lower than the threshold of the reference image differential motion vector (ThDmv) (NO in S604), the motion vector setting unit 205 sets the motion vector by a usual method (S607), and the flow goes to S606. The threshold of the reference image differential motion vector (ThDmv) is determined in advance by a predetermined method before the decoding processing is started.

When the error is not detected by the error detection unit 202 (NO in S603), when the input coded data is the image to which the motion compensation is performed (YES in S608), and when the input coded data is used as the reference image (YES in S609), the decoder 201 outputs a representative value of the reference image motion vector (MvX, MvY) and a representative value of the reference image differential motion vector (DmvX, DmvY) to the reference image motion vector operating unit 204 (S610).

The reference image motion vector operating unit 204 updates the sum of the motion vectors (SumMvX, SumMvY) and the sum of the absolute values of the reference image differential motion vectors (SumDmv) (S611). At this point, the sum of the absolute values of the reference image differential motion vectors (SumDmv) is updated using the sum of abs(DmvX) and abs(DmvY). Where abs(A) expresses an absolute value of A.

The decoder 201 outputs the reference image motion vector of the currently-coding block to the reference image motion vector setting unit 205 (S612).

The motion vector setting unit 205 sets the reference image motion vector output in S612 at the predetermined block of the image of the input coded data (S613), and the flow goes to S606.

When the error is not detected by the error detection unit 202 (NO in S603), when the coded data is the image to which the motion compensation is performed (YES in S608), and when the coded data is not the image used as the reference image (NO in S609), the flow goes to S612.

When the error is not detected by the error detection unit 202 (NO in S603), and when the coded data is not the image to which the motion compensation is performed (NO in S608), the digital image decoding processing of the second embodiment of the present invention is ended.

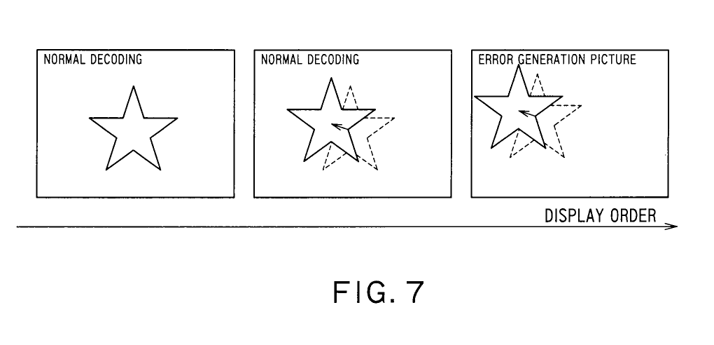

According to the second embodiment of the present invention, compared with the first embodiment of the present invention, the error concealment can be performed to the image to which the motion compensation is not performed while the storage area for the motion vector is not increased by one frame. Particularly, as shown in FIG. 7, because the error concealment is performed while the whole of the picture is represented by one reference image motion vector obtained by decoding the reference image without any error, the second embodiment of the present invention is effectively applied to the case in which the whole screen is evenly moving.

Additionally, according to the second embodiment of the present invention, the above-described effect can be achieved without increasing the memory capacity for the coding system such as MPEG2 in which the reference image motion vector is not retained for the purpose of usual decoding.

What is claimed is:

1. A digital image decoding apparatus which decodes coded data using plurality of motion vectors in each block obtained by dividing an image in frame to plurality of blocks, the digital image decoding apparatus comprising:
an error detection unit which detects an error of the block;
a decoder which decodes the coded data to generate the motion vector;
a motion vector setting unit which computes the motion vector of the block based on the motion vector generated by the decoder and sets the computed motion vector at the block; and
a motion compensating decoder which performs motion compensating decoding using the motion vector set by the motion vector setting unit,
wherein the decoder generates a reference image motion vector by decoding the coded data of the image which motion compensation is performed to and used as a reference image, and
when the error detection unit detects the error in the block of the image to which the motion compensation is not performed, the motion vector setting unit computes the motion vector of the block of the image to which the motion compensation is not performed based on the reference image motion vector generated by the decoder, and sets the computed motion vector at the block of the image to which the motion compensation is not performed.

2. The digital image decoding apparatus according to claim 1, wherein the decoder decodes the coded data of a P picture to generate the reference image motion vector, and
when the error detection unit detects an error in the block of an I picture, the motion vector setting unit computes the motion vector of the block of the I picture based on the reference image motion vector generated by the decoder, and sets the computed motion vector at the block of the I picture.

3. The digital image decoding apparatus according to claim 1, wherein the decoder decodes coded data of a picture including a P slice to generate the reference image motion vector, and
when the error detection unit detects the error in the block of a picture including only an I slice, the motion vector setting unit computes the motion vector of the block of the picture including only the I slice based on the reference image motion vector generated by the decoder, and sets the computed motion vector at the block of the picture including only the I slice.

4. The digital image decoding apparatus according to claim 1, further comprising a reference image motion vector memory in which the reference image motion vector is stored,
wherein the motion vector setting unit reads the reference image motion vector of the block located at a position identical to that of the block, in which the error is detected by the error detection unit and the motion compensation is not performed, in the reference image motion vectors stored in the reference image motion vector memory, computes the motion vector of the image to which the motion compensation is not performed based on the read reference image motion vector, and sets the computed motion vector at the block of the image, in which the error is detected by the error detection unit and the motion compensation is not performed.

5. The digital image decoding apparatus according to claim 1, further comprising a reference image motion vector operating unit which operates an average of the plurality of reference image motion vectors generated by the decoder and an average of absolute values of reference image differential motion vectors of the plurality of reference image motion vectors,
wherein, when the average of the absolute values of the reference image differential motion vectors operated by the reference image motion vector operating unit is lower than a predetermined value, the motion vector setting unit sets the average of the plurality of reference image motion vectors operated by the reference image motion vector operating unit at the block of the image, in which the error is detected by the error detection unit and the motion compensation is not performed.

6. The digital image decoding apparatus according to claim 5, wherein, when the coded data decoded by the decoder is a final block of a picture, the reference image motion vector operating unit updates the average of the reference image motion vectors and the average of the absolute values of the reference image differential motion vectors of the plurality of reference image motion vectors.

7. The digital image decoding apparatus according to claim 5, wherein, when the error detection unit does not detect any error in the block of the image to which the motion compensation is performed and which is used as the reference image, the reference image motion vector operating unit updates a total value of the motion vectors and a total value of the reference image differential motion vectors.

8. A digital image decoding method for decoding coded data using plurality of motion vectors in each block obtained by dividing an image in frame to plurality of blocks, the digital image decoding method comprising:
detecting an error of the block;
decoding coded data of an image to which the motion compensation is performed and which is used as the reference image to generate a reference image motion vector;
computing the motion vector of the image to which the motion compensation is not performed based on the reference image motion vector, and setting the computed motion vector at the block of the image to which the motion compensation is not performed, when the error is detected in the block of the image to which the motion compensation is not performed; and
performing motion compensating decoding using the set motion vector.

9. The digital image decoding method according to claim 8, wherein, in generating the reference image motion vector, the reference image motion vector is generated by decoding coded data of a P picture, and
when an error is detected in the block of an I picture, in setting the motion vector, the motion vector of the block of the I picture is computed based on the generated reference image motion vector, and the computed motion vector is set at the block of the I picture.

10. The digital image decoding method according to claim 8, wherein in generating the reference image motion vector, the reference image motion vector is generated by decoding coded data of a picture including a P slice, and
when an error is detected in the block of the picture including only an I slice, in setting the motion vector, the motion vector of the block of the picture including only the I slice is computed based on the generated reference image motion vector, and the computed motion vector is set at the block of the picture including only the I slice.

11. The digital image decoding method according to claim 8, wherein, after the reference image motion vector is generated, the generated reference image motion vector is stored,
in setting the motion vector,
the reference image motion vector of the block located at a position identical to that of the block, in which the error is detected and the motion compensation is not performed, is read in the reference image motion vectors stored in the reference image motion vector memory,
the motion vector of the image to which the motion compensation is not performed is computed based on the read reference image motion vector, and
the computed motion vector is set at the block of the image, in which the error is detected and to which the motion compensation is not performed.

12. The digital image decoding method according to claim 8, wherein, after the reference image motion vector is generated, an average of the generated plurality of reference image motion vectors and an average of absolute values of reference image differential motion vectors of the plurality of reference image motion vectors are operated,
in setting the motion vector,
when the average of the absolute values of the operated reference image differential motion vectors is lower than a predetermined value, the average of the operated plurality of reference image motion vectors is set at the block of the image, in which the error is detected and to which the motion compensation is not performed.

13. The digital image decoding method according to claim 12, wherein, in operating the reference image motion vector, when the decoded coded data is a final block of a picture, the average of the reference image motion vectors and the average of the absolute values of the reference image differential motion vectors of the plurality of reference image motion vectors are updated.

14. The digital image decoding method according to claim 12, wherein, in operating the reference image motion vector, when an error is not detected in the block of the image to which the motion compensation is performed and which is used as the reference image, a total value of the motion vectors and a total value of the reference image differential motion vectors are updated.
